(19) United States
(12) Patent Application Publication
(10) Pub. No.: US 2005/0238238 A1
(43) Pub. Date: Oct. 27, 2005

(54) Method and system for classification of semantic content of audio/video data

(76) Inventors: Li-Qun Xu, IPSWICH SUFFOLK (GB); Yongmin Li, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/521,732

(22) PCT Filed: Jul. 9, 2003
(86) PCT No.: PCT/GB03/03008

§ 371 Date: Jan. 19, 2005

(30) Foreign Application Priority Data
Jul. 19, 2002 (EP) 02255067.7

(51) Int. Cl. G06K 9/62; G10L 15/00

(52) U.S. Cl. 382/224; 382/159; 704/231

(57) ABSTRACT

Audio/Visual data is classified into semantic classes such as News, Sports, Music video or the like by providing class models for each class and comparing input audio visual data to the models. The class models are generated by extracting feature vectors from training samples, and then subjecting the feature vectors to kernel discriminant analysis or principal component analysis to give discriminatory basis vectors. These vectors are then used to obtain further feature vector of much lower dimension than the original feature vectors, which may then be used directly as a class model, or used to train a Gaussian Mixture Model or the like. During classification of unknown input data, the same feature extraction and analysis steps are performed to obtain the low-dimensional feature vectors, which are then fed into the previously created class models to identify the data genre.

### TECHNICAL FIELD

This invention relates to the classification of the semantic content of audio and/or video signals into two or more genre types, and to the identification of the genre of the semantic content of such signals in accordance with the classification.

### BACKGROUND TO THE INVENTION AND PRIOR ART

In the field of multimedia information-processing and content understanding, the issue of automated video genre classification from an input video stream is becoming of increased significance. With the emergence of digital TV broadcasts of several hundred channels and the availability of large digital video libraries, there are increasing needs for the provision of an automated system to help a user choose or verify a desired programme based on the semantic content thereof. Such a system may be used to “watch” a short segment of a video sequence (e.g. a clip of 10 seconds long), and then inform a user with confidence which genre (such as, for example, sport, news, commercial, cartoon, or music video ) of progrmamme the programme might be. Furthermore, on “scanning” through the video programme, the system may effectively identify, for example, a commercial break in a news report or a sport broadcast.

Conventional approaches for video genre classification or scene analysis tend to adopt a step-by-step heuristics-based inference strategy (see, for example, S. Fischer, R. Lienhart, and W. Effelsberg, “Automatic recognition of film genres,” Proceedings of ACM Multimedia Conference, 1995, or Z. Liu, Y. Wang, and T. Chen, “Audio feature extraction and analysis for scene segmentation and classification,” Journal of VLSI Signal Processing Systems, Special issue on Multimedia Signal Processing, pp 61-79, October 1998). They usually proceed by first extracting certain low-level visual and/or audio features, from which an attempt is made to build the so-called intermediate-level semantics representation (signatures, style attributes etc) that is likely to be specific to any certain genre. Finally the genre identity is hypothesised and verified using precompiled knowledge-based heuristic rules or learning methods. The main problem with these approaches is the need of using a combination of many different styles' attributes for content recognition. It is not known what the most significant attributes are, or what the style profiles (rules) of all major video genre are in terms of these attributes.

Recently, a data-driven statistically based video genre modelling approach has been developed, as described in M. J. Roach and J. S. D. Mason, “Classification of video genre using audio,” Proceedings of Eurospeech'2001 and M. J. Roach, J. S. D. Mason, L.-Q. Xu “Classification of non-edited broadcast video using holistic low-level features,” to appear in Proceedings of International Workshop on Digital Communications: Advanced Methods for Multimedia Signal Processing (IWDC'2002), Capri, Italy. With such a method the video genre classification task is cast into a data modelling and classification problem through a direct analysis of the relationship between low-level feature distributions and genre identities. The main challenges faced by this approach are two-fold. First, the fact that a genre, e.g. commercial, covers a wide range of video styles/contents/semantic structures means there exists inevitably large within-class feature sample variations. Second, owing to the short-term (i.e. local) based analysis the boundaries between any two genres, e.g. music video and commercial, are often not clearly defined. So far these issues have not been properly addressed. In the following we give a more detailed analysis of this method.

Motivated by the apparent success in the field of text-independent speaker recognition (see for example D. A. Reynolds and R. C. Rose, “Robust text-independent speaker identification using Gaussian mixture speaker models,” IEEE Trans. on Speech and Audio Processing, Vol. 3, No. 1, pp 72-83, 1995), in previous works, the Gaussian Mixture Model (GMM) was introduced to model the class-based probabilistic distribution of audio and/or visual feature vectors in a high-dimensional feature space. These features are computed directly from successive short segments of audio and/or visual signals of a video sequence, accounting for e.g. 46 ms audio information or 640 ms visual information albeit in a crude representation, respectively (see M. J. Roach, J. S. D. Mason, L.-Q. Xu, “Classification of non-edited broadcast video using holistic low-level features.” To appear in Proceedings of International Workshop on Digital Communications: Advanced Methods for Multimedia Signal Processing (IWDC'2002), Capri, Italy.). In M. J. Roach and J. S. D. Mason, “Classification of video genre using audio,” Proceedings of Eurospeech'2001 and M. J. Roach, J. S. D. Mason, and M. Pawlewski, “Video genre classification using dynamics,” Proceedings of ICASSP'2001 Roach et al. proposed to learn a “world” model in the first instance, which was then used to facilitate the training of “each” individual class model to compensate for the lacking of enough training data for each class. In their work, as many as 256 and 512 Gaussian components or more were used. No explicit or sensible temporal information of the video stream at a segmental level is incorporated except that the acoustic feature used has built into it some short-term (e.g. 138 ms) transitional changes. This assumption that the successive feature vectors from the source video sequence are largely independent of each other is not appropriate.

Another problem with the GMM is the “curse of dimensionality”; therefore it is not normally used for handling data in a very high dimensional space due to the need of a large amount of training data, rather low dimensional features are adopted. For example, In M. J. Roach, J. S. D. Mason, and M. Pawlewski, “Video genre classification using dynamics,” Proceedings of ICASSP'2001 the dimension of a typical feature vector is 24 in the case of simplistic dynamic visual features, and 28 when using Mel-scaled cepstral coefficients (MFCC) plus delta-MFCC acoustic features.

In classification (operational) mode, given an appropriate decision time window, all the feature vectors falling within the window from a test video are fed to the class-labelled GMM models. The model with the highest accumulated log-likelihood is declared to be the winner, to which class the video genre belongs.

Meanwhile, subspace data analysis has also been of great interest in this area, especially when the dimensionality of data samples is very high. Principal Component Analysis (PCA) or KL transform, one of the most often used subspace analysis methods, involves a linear transformation that represents a number of usually correlated variables into a smaller number of uncorrelated variables—orthonormal basis vectors—called principal components. Normally, the first few principal components account for most of the variation in the data samples used to construct the PCA.

However, PCA seeks to extract the “global” most expressive features in the sense of least mean squared residual error. It does not provide any discriminating features for multi-class classification problems. To deal with this problem, Linear Discriminant Analysis (LDA) (see R. Fisher, “The statistical utilization of multiple measurements,” Annals of Eugenics, Vol. 8, pages 376-386, 1938, and K. Fukunaga. Introduction to statistical pattern recognition. Academic Press. 1972) was developed to compute a linear transformation that maximises the between-class variance and minimises the within-class variance. Daniel L. Swets and John (Juyang) Weng in “Using discriminant eigenfeatures for image retrieval,” IEEE Trans. on Pattern Analysis and Machine Intelligence, Vol. 18, No. 8, pp 831-836, August 1996. used the LDA for face recognition and whilst discounting the within-class variance due to lighting and expression, the LDA features of all the training samples are stored as models. The recognition of a new sample (face) is done using the k-Nearest Neighbour technique; no attempts were made in modelling the distributions of the LDA features. The main reason as quoted is the high-dimensionality of the data space, also there are too many classes (603) and too few samples for each class (ranging from 2 to 14) to actually estimate the probability distributions at all.

However, LDA suffers from the performance degradation when the patterns of different classes cannot be linearly separable. Another shortcoming of LDA is that the possible number of basis vectors, i.e. the dimension of the LDA feature space, is equal to C−1 where C is the number of classes to be identified. Obviously, it cannot provide an effective representation for problems with a small number of classes while the pattern distribution of each individual class is complicated.

In “Kernel principal component analysis,” Proceedings of ICANN'97, 583-588, Berlin 1997, Bernhard Scholkopf, A. Smola, and K-R Muller presented Kernel PCA (KPCA) that is capable of modelling the non-linear variation through a kernel function. The basic idea is to project the original data onto a high-dimensional feature space and utilise a linear PCA there based on an assumption that the variation in the feature space is linear.

As will be apparent from the above discussion, subspace data analysis methods can afford to deal with very high-dimensional features. On considering the exploitation of this characteristic further and the use of such kind of methods to video analysis tasks, we recognise the two important domain specific issues have to be addressed. First, the temporal structure (or dynamic) information is crucial, as manifested at different time scales by various meaningful instantiations of a genre, and therefore must be embedded into the feature sample space, which could be very complex. Second, the between-class (genre) variance of the data samples should be maximised and the within-class (genre) variance minimised so those different video genres can be modelled and distinguished more efficiently. With these in mind we now take a close look at a most recent development of the non-linear subspace analysis method—Kernel Discriminant Analysis (KDA).

As discussed above, PCA is not intrinsically designed for extracting discriminating features, and LDA is limited to linear problems. In this work, we adopt KDA to extract the non-linear discriminating features for video genre classification.

With reference to FIG. 3, the rationale of KDA can be briefly described as follows. For a given set of multi-class data samples, if we cannot separate the data directly using linear techniques, e.g. LDA, we can project the data through a non-linear mapping onto a high-dimensional feature space where the data are linearly separable. Then we apply LDA in the feature space to solve the problem. It is important to note that the computation does not need to be performed in the high-dimensional feature space otherwise it would be very expensive. By using a kernel function that corresponds to the non-linear mapping, the problem can be solved conveniently in the original input space.

Formally, KDA can be computed using the following algorithm (see Yongmin Li et al. “Recognising trajectories of facial identities using Kernel Discriminant Analysis,” Proceedings of British Machine Vision Conference, pp 613-622, Manchester, September 2001). For a set of training patterns {x}, which are categorised into C classes, φ is defined as a non-linear map from the input space to a high-dimensional feature space. Then by performing LDA in the feature space, one can obtain a non-linear representation for the patterns in the original input space. However, computing φ explicitly may be problematic or even impossible. By employing a kernel function
k(x, y)=(φ(x)·φ(y)) (1)
the inner product of two vectors x and y in the feature space can be calculated directly in the input space.
The problem can be finally formulated as an eigen-decomposition problem
Aα=λα (2)
The N×N matrix A is defined as

$$A = {( {\sum }_{c = 1}^{C} \frac{1}{{N}_{c}} {K}_{c} {K}_{c}^{T} )}^{- 1} ( {\sum }_{c = 1}^{C} \frac{1}{{N}_{c}^{2}} {K}_{c} {1}_{{N}_{c}} {K}_{c}^{T} ) , \qquad ( 3 )$$

where N is the number of all training patterns, N_{c} is the number of patterns in class c, (K_{c})ᵢⱼ:=k(xᵢ, xⱼ) is an N×N_{c} kernel matrix, and (1_{N}_{_{c}})ᵢⱼ:=1 is an N_{c}×N_{c} matrix.

Assuming that v is an imaginary basis vector in the high-dimensional feature space, one can calculate the projection of a new pattern x onto the basis vector v by
(φ(x)·v)=α^{T}kₓ (4)
where kₓ=(k(x, x₁), k(x, x₂), . . . , k(x, x_{N}))^{T}. Constructing the eigen-matrix U=[α₁, α₂, . . . , α_{M}] from the first M significant eigenvectors of A, the projection of x in the M-dimensional KDA space is given by
y=U^{T}kₓ (5)

The characteristics of KDA can be illustrated in FIG. 4 by a theoretical problem, being that of to separate two classes of patterns (denoted as crosses and circles respectively) with significant non-linear distribution. We compare the result of KDA with those of PCA, LDA and KPCA. The upper row of FIGS. 4(a), (b), (c), and (d) show the respective patterns and the optimal separating boundary using a one-dimensional feature computed from PCA, LDA, KPCA or KDA respectively from (a) to (d), while the lower row of each Figure shows the respective values of the one-dimensional feature as image intensity (white for big value and dark for small value). It is noted from FIGS. 4(a), (b), and (c) that PCA, LDA and KPCA cannot solve this non-linear problem satisfactorily. However, KDA (as shown in FIG. 4(d)) performs very well: the two classes of patterns are separated correctly and the feature precisely reflects the distribution of patterns.

In view of the present video and audio genre content identification techniques which exhibit weaknesses with the conventional step-by-step heuristics-based approaches for video genre classification and also problems faced by the current data-driven statistically based video genre modelling approach, there is clearly a need for a new genre content identification method and system which overcomes these problems and achieves more robust classification and verification results with minimum human intervention.

### SUMMARY OF THE INVENTION

The invention addresses the above problems by directly modelling the semantic relationship between low-level features distribution and its global genre identities without using any heuristics. By doing so we have incorporated compact spatial-temporal audio-visual information and introduced enhanced feature class discriminating abilities by adopting an analysis method such as Kernel Discriminant Analysis or Principal Component Analysis. Some of the key contributions of this invention consist in three aspects; first, the seamless integration of short-term audio-visual features for complete video content description; second, the embodiment of proper video temporal dynamics at a segmental level into the training data samples; and thirdly in the use of Kernel Discriminant Analysis or Principal Component Analysis for low-dimensional abstract feature extraction.

In view of the above, from a first aspect the present invention presents a method of generating class models of semantically classifiable data of known classes, comprising the steps of:
for each known class:
   extracting a plurality of sets of characteristic feature vectors from respective portions of a training set of semantically classifiable data of one of the known classes; and
   combining the plurality of sets of characteristic features into a respective plurality of N-dimensional feature vectors specific to the known class;
wherein respective pluralities of N-dimensional feature vectors are thus obtained for each known class; the method further comprising:
analysing the pluralities of N-dimensional feature vectors for each known class to generate a set of M basis vectors, each being of N-dimensions, wherein M<<N; and
for any particular one of the known classes:
   using the set of M basis vectors, mapping each N-dimensional feature vector relating to the particular one of the known classes into a respective M-dimensional feature vector; and
   using the M-dimensional feature vectors thus obtained as the basis for or as input to train a class model of the particular one of the known classes.

The first aspect therefore allows for class models of semantic classes to be generated, which may then be stored and used for future classification of semantically classifiable data.

Therefore, from a second aspect the invention also presents a method of identifying the semantic class of a set of semantically classifiable data, comprising the steps of:
extracting a plurality of sets of characteristic feature vectors from respective portions of the set of semantically classifiable data;
combining the plurality of sets of characteristic features into a respective plurality of N-dimensional feature vectors;
mapping each N-dimensional feature vector to a respective M-dimensional feature vector, using a set of M basis vectors previously generated by the first aspect of the invention, wherein M<<N;
comparing the M-dimensional feature vectors with stored class models respectively corresponding to previously identified semantic classes of data; and
identifying as the semantic class that class which corresponds to the class model which most matched the M-dimensional feature vectors.

The second aspect allows input data to be classified according to its semantic content into one of the previously identified classes of data.

In one embodiment the set of semantically classifiable data is audio data, whereas in another embodiment the set of semantically classifiable data is visual data. Moreover, within a preferred embodiment the set of semantically classifiable data contains both audio and visual data. The semantic classes for the data may be, for example, sport, news, commercial, cartoon, or music video.

The analysing step may use Principal Component Analysis (PCA) to perform the analysis, although within the preferred embodiment the analysing step uses Kernel Discriminant Analysis (KDA). The KDA is capable of minimising within-class variance and maximising between-class variances for a more accurate and robust multi-class classification.

In the preferred embodiment the combining step further comprises concatenating the extracted characteristic features into the respective N-dimensional feature vectors. Where audio and visual data are present within the input data, the data is normalised prior to concatenation.

In addition to the above, from a third aspect the invention provides a system for generating class models of semantically classifiable data of known classes, comprising:
feature extraction means for extracting a plurality of sets of characteristic feature vectors from respective portions of a training set of semantically classifiable data of one of the known classes; and
feature combining means for combining the plurality of sets of characteristic features into a respective plurality of N-dimensional feature vectors specific to the known class;
the feature extraction means and the feature combining means being repeatably operable for each known class, wherein respective pluralities of N-dimensional feature vectors are thus obtained for each known class;
the system further comprising:
processing means arranged in operation to:
   analyse the pluralities of N-dimensional feature vectors for each known class to generate a set of M basis vectors, each being of N-dimensions, wherein M<<N; and
   for any particular one of the known classes:
      use the set of M basis vectors, map each N-dimensional feature vector relating to the particular one of the known classes into a respective M-dimensional feature vector; and
      use the M-dimensional feature vectors thus obtained as the basis for or as input to train a class model of the particular one of the known classes.

In addition from a fourth aspect there is also provided a system for identifying the semantic class of a set of semantically classifiable data, comprising:
feature extraction means for extracting a plurality of sets of characteristic feature vectors from respective portions of the set of semantically classifiable data;
feature combining means for combining the plurality of sets of characteristic features into a respective plurality of N-dimensional feature vectors;
storage means for storing class models respectively corresponding to previously identified semantic classes of data; and
processing means for:
   mapping each N-dimensional feature vector to a respective M-dimensional feature vector, using a set of M basis vectors previously generated by the third aspect of the invention, wherein M<<N;
   comparing the M-dimensional feature vectors with the stored class models; and
identifying as the semantic class that class which corresponds to the class model which most matched the M-dimensional feature vectors.

In the third and fourth aspects the same advantages and further features can be obtained as previously described in respect of the first and second aspects.

From a fifth aspect the present invention further provides a computer program so arranged such that when executed on a computer it causes the computer to perform the method of any of the previously described first or second aspects.

Moreover, from a sixth aspect, there is also provided a computer readable storage medium arranged to store a computer program according to the fifth aspect of the invention. The computer readable storage medium may be any magnetic, optical, magneto-optical, solid-state, or other storage medium capable of being read by a computer.

### BRIEF DESCRIPTION OF THE DRAWINGS

Further features and advantages of the present invention will become apparent from the following description of an embodiment thereof, presented by way of example only, and made with reference to the accompanying drawings, wherein like reference numerals refer to like parts, and wherein:

FIG. 1 is an illustration showing a general purpose computer which may form a basis of the embodiments of the present invention;

FIG. 2 is a schematic block diagram showing the various system elements of the general purpose computer of FIG. 1;

FIG. 3 is a diagram showing the operation of Kernel Discriminant Analysis;

FIGS. 4(a)-(d) represent a sequence of graphs illustrating the solutions to a theoretical problem using, PCA, LDA, KPCA and KDA, respectively;

FIG. 5 is a block diagram showing the modules involved in the learning and representation of video genre class identities in an embodiment of the present invention;

FIG. 6 is a block diagram showing the modules involved in the computation of spatial-temporal audio-visual feature, or training samples in an embodiment of the present invention;

FIG. 7 is a block diagram illustrating the video genre classification module of an embodiment of the invention; and

FIG. 8 is a timing diagram illustrating the synchronisation of audio and visual features in an embodiment of the present invention.

### DESCRIPTION OF THE EMBODIMENTS

An embodiment of the invention will now be described. As the invention is primarily embodied as computer software running on a computer, the description of the embodiment will be made essentially in two parts. Firstly, a description of a general purpose computer which forms the hardware of the invention, and provides the operating environment for the computer software will be given. Then, the software modules which form the embodiment and the operation which they cause the computer to perform when executed thereby will be described.

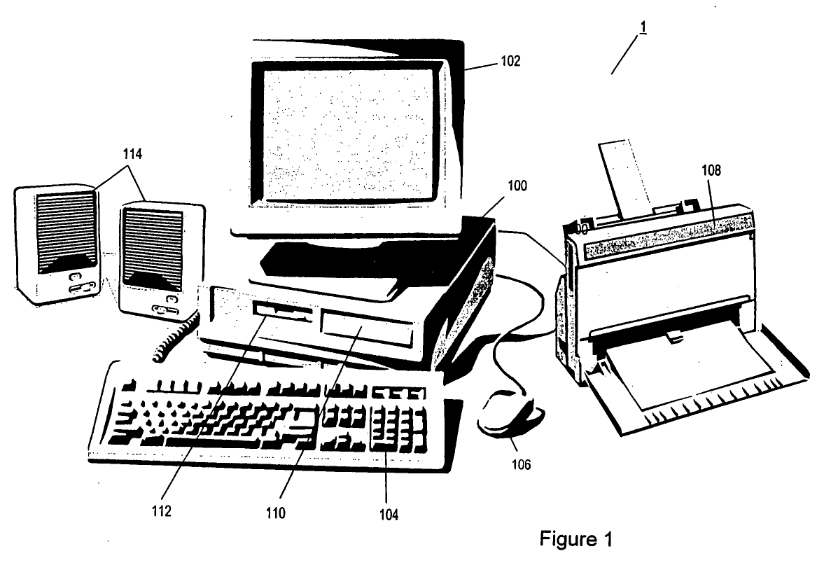

FIG. 1 illustrates a general purpose computer system which, as mentioned above, provides the operating environment of an embodiment of the present invention. Later, the operation of the invention will be described in the general context of computer executable instructions, such as program modules, being executed by a computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 1, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

With specific reference to FIG. 1, a general purpose computer system 1 which may form the operating environment of an embodiment of an invention, and which is generally known in the art comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 1 illustrates an exemplary embodiment only, and that other configurations of computer systems are possible which can be used with the present invention. In particular, the base chassis unit 100 may be in a tower configuration, or alternatively the computer system 1 may be portable in that it is embodied in a lap-top or note-book configuration. Other configurations such as personal digital assistants or even mobile phones may also be possible.

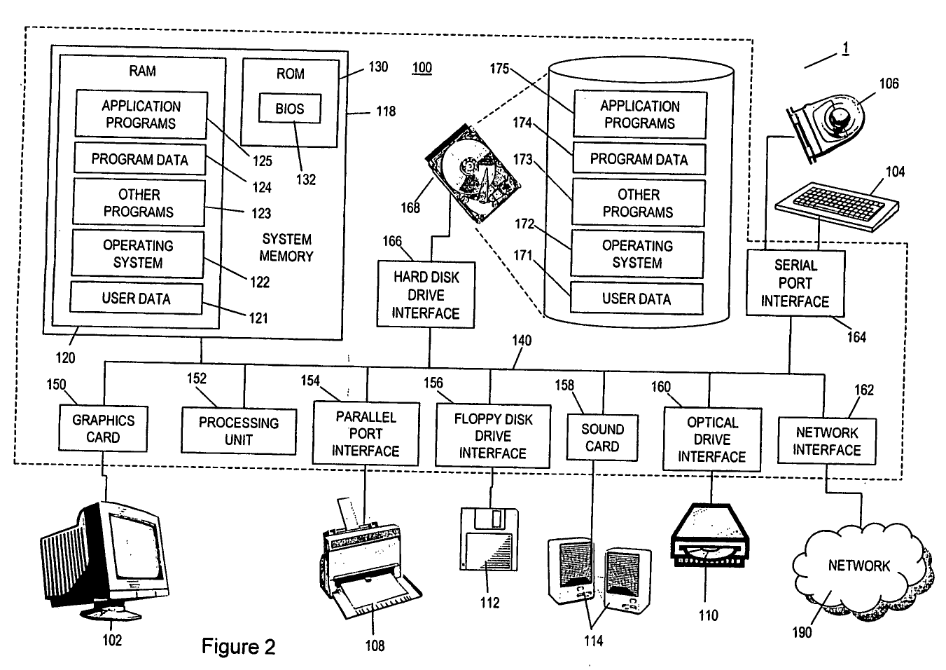

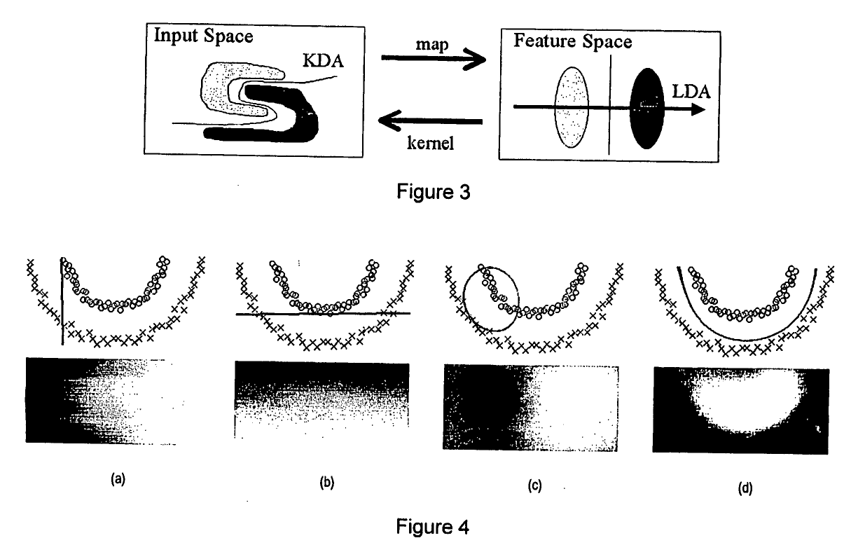

FIG. 2 illustrates a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this embodiment provides a control output to the printer 108; and a floppy disk drive interface 156 which controls the floppy disk drive 112 so as to read data from any floppy disk inserted therein, or to write data thereto. The graphics card 150 may also include a video input to allow the computer to receive a video signal from an external video source. In addition, the graphics card 150 or another separate card (not shown) may also have the ability to receive and demodulate television signals. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. In particular, IEEE 802.11 wireless LAN networks may be of particular use to allow for mobility of the computer system. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, or floppy disks used with the floppy disk 112 provide non-volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs required by the computer system 1 or the user 173, a computer system operating system 172 such as Microsoft® Windows®, Linux™, Unix™, or the like, as well as user data in the form of files, data structures, or other data 171. The hard disk drive 168 provides non volatile storage of the aforementioned programs and data such that the programs and data can be permanently stored without power.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow for the system to boot-up.

Whilst FIG. 2 illustrates one embodiment of the invention, it will be understood by the skilled man that other peripheral devices may be attached to the computer system, such as, for example, microphones, joysticks, game pads, scanners, or the like. In addition, with respect to the network interface 162, we have previously described how this is preferably a wireless LAN network card, although equally it should also be understood that the computer system 1 may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, it should further be understood that the application programs, other programs, and other data which may be stored locally in the computer system may also be stored, either alternatively or additionally, on remote computers, and accessed by the computer system 1 by logical connections formed over the network 190.

Having described the hardware required in the embodiment of the invention, in the following we now describe the system framework of our embodiment for video genre classification, explaining the functionality of various software component modules. This is followed by a detailed analysis on composing a compact spatial-temporal feature vector at a video segmental level encapsulating the generic semantic content of a video genre. Note that within the following such a feature vector is called both a “sample” or a “sample vector” interchangeably.

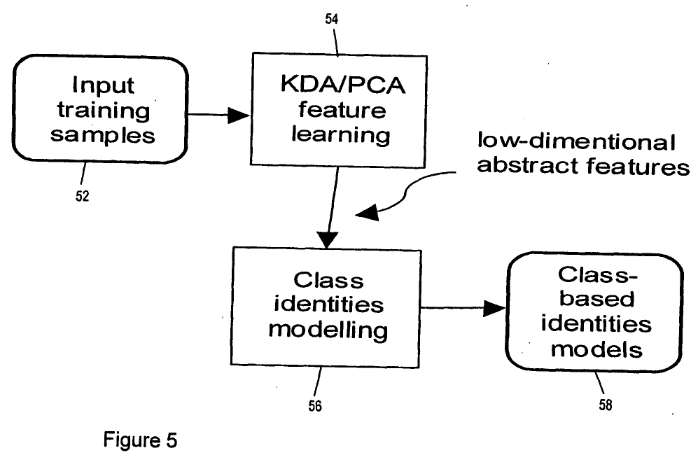

FIGS. 5, 6, and 7 respectively illustrate the three important software modules of the embodiment, namely a class-identities learning module, a feature extraction module, and a classification module. These are discussed in detail next.

The video class-identities learning module is shown schematically in FIG. 5. The learning module comprises a KDA/PCA feature learning module 54 which is arranged to receive input training samples 52 therein, and to subject these samples to KDA/PCA. A number of class discriminating features thus obtained are then output to a class identities modelling module 56.

The input (sequence of) training samples have been carefully designed and computed to contain characteristic spatial-temporal audio-visual information over the length of a small video segment. These sample vectors being inherently non-linear in the high dimensional input space are then subject to KDA/PCA to extract the most discriminating basis vectors that maximise the between-class variance and minimise the within-class variance. Using the first M significant basis vectors, each input training sample is mapped, through a kernel function, onto a feature point in this new M-dimensional feature space (c.f. equation (5)).

At the class identities modelling module 56, the distribution of the features in the M-dimensional feature space belonging to each intended class can then be further modelled using any appropriate techniques. The choices for further modelling could range from using no model at all (i.e. simply storing all the training samples for each class), the K-Means clustering method, to adopting the GMM or a neural network such as the Radial basis function (RBF) network. Whichever modelling method is used (if any), the resulting model is then output from the class identities learning module 56 as a class identity model 58, and stored in a model store (not shown, but for example the system memory 118, or the hard disk 168) for future use in data genre classification. In addition, the M significant basis vectors are also stored, with the class models. Thus, the video class-identities learning module allows a training sample of known class to be input therein, and then generates a class based model, which is then stored for future use in classifying data of unknown genre class by comparison thereagainst.

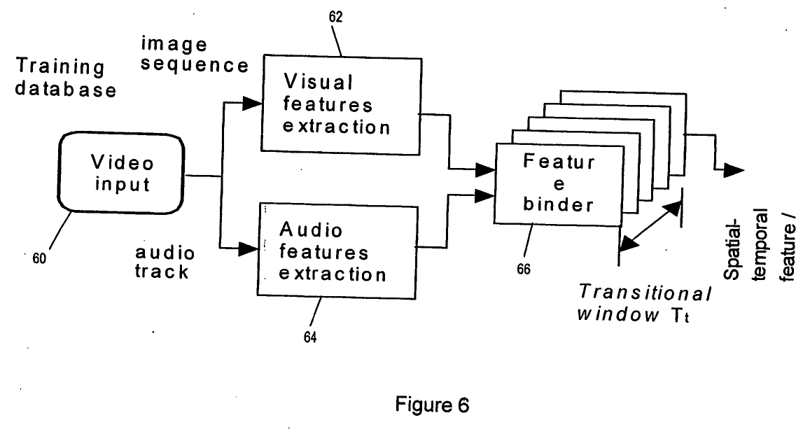

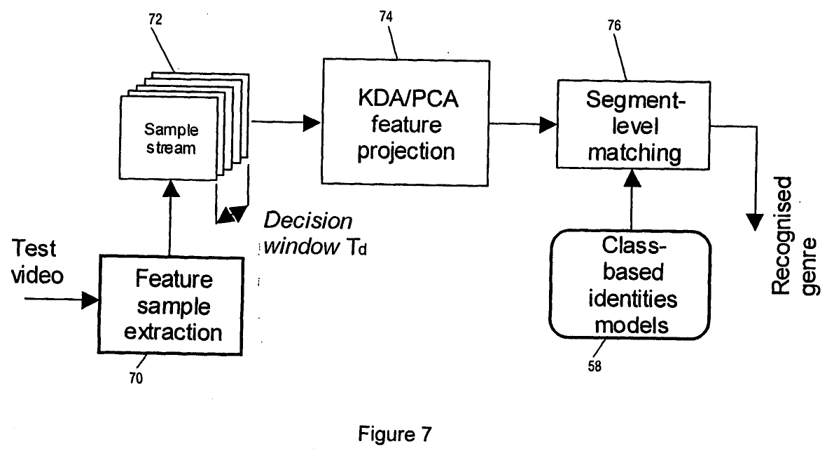

FIG. 6 illustrates the feature extraction module, which controls the chain of processes by which the input training sample vectors are generated. The output of the feature extraction module, being sample vectors of the input data, may be used in both the class-identities learning module of FIG. 5 and the classification module of FIG. 7, as appropriate.

With reference to FIG. 6, the feature extraction module 70 (see FIG. 7) comprises a visual features extractor module 62, and an audio features extractor module 64. Both of these modules receive as an input audio-visual data from a training database 60 of video samples, the visual features extractor module 62 receiving the video part of the sample, and the audio features extractor module receiving the audio part. The training database 60 is made up of all the video sequences belonging to each of the C video genre to be classified; there are about the same amount of data collected for each class.

For each consecutive two video frames, the prominent visual features e.g. a selection of those motion/colour/texture descriptors discussed in MPEG-7 “Multimedia Content Description Interface” (see Sylvie Jeannin and Ajay Divakaran, “MPEG-7 Visual Motion Descriptors,” IEEE Trans. on Circuits and Systems for Video Technology, Vol. 11, No. 6, June 2001 and B. S. Manjunath, Jens-Rainer Ohm, Vinod V. Vasudevan, and Akio Yamada, “Color and texture descriptors,” IEEE Trans. on Circuits and Systems for Video Technology, Vol. 11, No. 6, June 2001) are computed by the visual features extractor 62. Correspondingly, the audio track is analysed by the audio features extractor 64, and the characteristic acoustic features, e.g. short-term spectral estimation, fundamental frequency etc, are extracted and if necessary synchronised with the visual information over the 40 ms video frame interval. The audio-visual features thus computed by the two extractors are then fed to the feature binder module 66. Here, those features that fall within a predefined transitional window Tₜ are normalised and concatenated to form a high-dimensional spatial-temporal feature vector, i.e. the sample. More detailed consideration of the operation of the feature binder, and of the properties of the feature vectors, is given next.

It should be noted here that the invention as here described can be applied to any good semantics-bearing feature vectors extracted from the video content, i.e. from the visual image sequences and/or its companion audio sequence. That is, the invention can be applied to audio data only, visual data only, or both audio and visual data together. These three possibilities are discussed in turn below.

In comparison with the tasks of pattern/object recognition, the video genre classification is potentially more challenging. First, there is only a notional “class” label assigned to a video segment by a human user, the underlying data structure (signatures/identities) of the “same class” could be quite different. Second, the dynamics (temporal variation) embedded in the segment could be essential in differentiating the semantics of different classes. These properties, however, have also brought us with many opportunities to exploit a rich set of features for content/semantics characterisation. As mentioned in the previous paragraph, the feature vectors can assume either a visual mode or an acoustic (audio) mode, or indeed the combined audio-visual mode, as discussed respectively below.

Regarding visual features first, assume a typical video frame rate of 25 fps, or 40 ms frame interval. If for each frame, the number of holistic spatial-temporal features (explaining e.g. motion/colour/texture) extracted is n^{v}=100, then the equivalent number of video frames that can be packed into one training sample would be ˜25344/n^{v}≈250 to reach the comparable space dimension of a QCIF (144×176) image used in object recognition task. This would account for about 10 seconds long video, while only one single frame (equally 40 ms) can be stored with the original image dimension! This is however too long, and the training operation for a class model may never converge. In practice therefore we consider analysing a one-second long video clip at one time, corresponding to 25 video frames that gives an input feature space of 2500 dimensions.

For audio features, assume an audio sampling rate of 11,025 Hz (or down sampled by a factor of 4 from the CD quality rate 44.1 kHz). If we estimate the short-term spectrum using an analysis window of 23 ms long, and the window shifts by 10 ms, the acoustic parameters computed are 12th-order MFCC and its transitional features, or 12 delta MFCC. To synchronise the audio stream with the video frame rate, the dimension of the acoustic feature vector would be, n^{a}=4(nₛ^{a}+nₜ^{a})=4(12+12)=96, where superscript a denotes audio feature. For a one-second long audio clip this amounts to 2400 dimension by simple concatenation.

Finally, for audio-visual features, either the visual or audio features discussed above can be used alone for video content description and genre characterisation. However, it does not make sense if we are not taking advantage of the complementary and richer expressive and discriminative power of the combined audio-visual multimedia feature. For an illustrative purpose, we use the figures mentioned above by simply concatenating the two, then the number of synchronised audio-visual features over one-second long video clip is n^{clip}=25(n^{a}+n^{v})=25(96+100)=4900. Note that proper normalisation is needed to form this feature vector sample. It is also noted from FIG. 6 that this final sample vector corresponds to a transitional window of Tₜ=1000 ms.

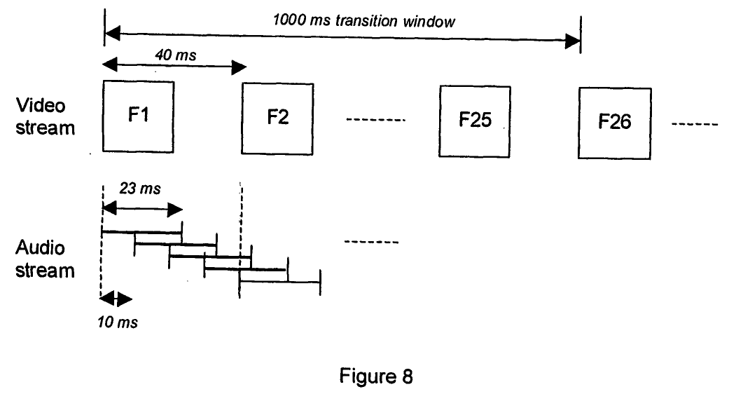

When considering both audio and video data together, however, there is an additional concern that synchronisation between the two must be taken into account. An illustration of an audio-visual feature synchronisation step performed by the feature binder 66 is given in FIG. 8. Here, within a given transition window, e.g. 1000 ms, the visual features as extracted from an image sequence of 25 frames are alternatively concatenated with audio features from corresponding audio stream, after going through proper Gaussian-based normalisation. Normalisation is done for each element by subtracting from it a global mean value, followed by a division by its standard deviation. For FIG. 8, the final composed high-dimensional feature vector would look like:
X={V₁A_{1,1}A_{1,2}A_{1,3}A_{1,4}V₂A_{2,1}A_{2,2} A_{2,3}A_{2,4} . . . V₂₅A_{25,1}A_{25,2}A_{25,3}A_{25,4}}
where Vᵢ denotes visual feature vector extracted and normalised for frame i, and A_{i,1} A_{i,2} A_{i,3} A_{i,4} represents corresponding audio features extracted and normalised for a visual frame interval, 40 ms in this case.

The feature binder 66 therefore outputs a sample stream of feature vectors bound together into a high-dimensional matrix structure, which is the used as the input to the KDA analyser module. The input to the feature extraction module 70 as a whole may be either known data of known class and which is to be used to generate a class model or signature thereof, or data of unknown class which is required to be classified. The operation of the classification (recognition) module which performs such classification will be discussed next.

FIG. 7 shows the diagram of the video genre recognition module. The recognition module comprises the feature extraction module 70 as previously described and shown in FIG. 6, a KDA/PCA analysis module 74 arranged to receive sample vectors output from the feature extraction module 70, and a segment level matching module 76 arranged to receive discriminant basis vectors from the KDA/PCA analysis module 74. The segment level matching module 76 also accesses previously created class identity models 58 for matching theregainst. On the basis of any match a signal indicative of the recognised video genre (or class) is output therefrom.

In view of the above arrangement, the detailed operation of the recogntion module is as follows. A test video segment first undergoes the process of the same feature extraction module 70 as shown in FIG. 6 to produce a sequence of spatial-temporal audio-visual sample features. The consecutive samples falling within a pre-defined defined decision window T_{d} are then projected via a kernel function onto the discriminating KDA/PCA basis vectors, by the KDA/PCA analysis module 74. These discriminating basis vectors are the M significant basis vectors obtained by the class identifies learning module during the class learning phase, and stored thereby. The sequence of new M dimensional feature vectors thus obtained by the projection is subsequently fed to the segment-level matching module 76, wherein they are compared with the class-based models 58 learned before; the class model that matches the sequence best in terms of either minimal similarity distance or maximal probabilistic likelihood is declared to be the genre of the current test video segment. The choice of an appropriate similarity measure depends on the class-based identities models adopted.

One of the important parameters worthy of more discussion is the decision time window T_{d}, by which we mean the time interval when an answer is required as to the genre of the video programme the system is monitoring. It could be 1 second, 15 seconds, or 30 seconds. The choice is application-dependent, as some demand immediate answers, whilst others can afford certain reasonable delays. There is also a trade-off existing between the accuracy of the classification and the decision time desired, as a longer decision window tends to encapsulate richer contextual or temporal information, which in turn is expected to deliver more robust performance in terms of low false acceptance (positive) and false rejection (negative) rate.

We turn now to a brief discussion of the computational complexity considerations of the embodiment of the invention. Assume a collection of large video database that contains five video genre including news, commercial, music video, cartoon, and sport, each being made up of a number of recorded video clips. The total length of each genre is about two hours, so that gives an overall of 10 hours source video data at our disposal, most of which being selected from the MPEG-7 test data set. In the experiments described, one hour long material for each genre is used for training, and the other one hour for testing.

In view of discussions above and adopting a one-second (25-frame) transitional window, or Tₜ=1000 ms, we now have a training sample size N=5×3600=18,000, and N_{c}=3600 for each class c=1, 2, . . . , 5, in a 4900-dimensional feature space. These samples are then subjected to KDA analysis to extract the most discriminant basis vectors. We experiment with M=20 basis vectors, the samples in each class is then projected via the kernel function onto these basis vectors to give rise to new feature clusters. A non-parametric or parametric modelling method as described by Richard O. Duda, Peter E. Hart and David G. Stork in Pattern Classification and Scene Analysis Part 1: Pattern Classification, 2^{nd} edition, Wiley, New York, 2000 is then employed to characterise the class-based sample distributions.

One of the main drawbacks with the KDA, and in fact with any kernel-based analysis method, is the computational complexity related to the size of the training set N (c.f. the kernel function matrix kₓ in equation (5)). We propose to randomly select the original training data set for each class by a factor of 5, which gives us a total of N=3600 training samples to work on, with N_{c}=720 samples for each class.

Adopt a Gaussian kernel function,

$$k ( x , y ) = exp ( - \frac{{‖ x - y ‖}^{2}}{2 {σ}^{2}} ) \qquad ( 6 )$$

where 2σ²=1.

Using Equation (3) we can derive the matrix A of N×N=3600×3600. By eigen-decomposing this matrix, we can then obtain a set of N-dimensional eigen (basis) vectors (α₁, α₂, . . . , α_{N}), corresponding to in descent order the eigen values (λ₁, λ₂, . . . , λ_{N}). If we construct the eigen-matrix using the first M significant eigenvectors, or U=[α₁, α₂, . . . α_{M}], the size of which is N×M=3600×M, then for a new data sample vector x in the original input space, its projection onto v in the M-dimensional feature space can be computed using equation (5).

Apparently, there is another trade-off here: A large training ensemble tends to give better class identities model representation, leading to accurate and robust classification results, but in return it demands longer computational time. Note that, in the discussions above, the input feature samples to KDA analysis module are assumed to be zero mean or centred data. If they are not then modifications should be made according to the description in Yongmin Li et al. “Recognising trajectories of facial identities using Kernel Discriminant Analysis,” Proceedings of British Machine Vision Conference, pp 613-622, Manchester, September 2001.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

Moreover, for the avoidance of doubt, where reference has been given to a prior art document or disclosure, whose contents, whether as a whole or in part thereof, are necessary for the understanding of the operation or implementation of any of the embodiments of the present invention by the intended reader, being a man skilled in the art, then said contents should be taken as being incorporated herein by said reference thereto.

1. A method of generating class models of semantically classifiable data of known classes, comprising the steps of:
for each known class:
extracting a plurality of sets of characteristic feature vectors from respective portions of a training set of semantically classifiable data of one of the known classes; and
combining the plurality of sets of characteristic features into a respective plurality of N-dimensional feature vectors specific to the known class;
wherein respective pluralities of N-dimensional feature vectors are thus obtained for each known class; the method further comprising:
analysing the pluralities of N-dimensional feature vectors for each known class to generate a set of M basis vectors, each being of N-dimensions, wherein M<<N; and
for any particular one of the known classes:
using the set of M basis vectors, mapping each N-dimensional feature vector relating to the particular one of the known classes into a respective M-dimensional feature vector; and
using the M-dimensional feature vectors thus obtained as the basis for or as input to train a class model of the particular one of the known classes.

2. A method of identifying the semantic class of a set of semantically classifiable data, comprising the steps of:
extracting a plurality of sets of characteristic feature vectors from respective portions of the set of semantically classifiable data;
combining the plurality of sets of characteristic features into a respective plurality of N-dimensional feature vectors;
mapping each N-dimensional feature vector to a respective M-dimensional feature vector, using a set of M basis vectors previously stored, wherein M<<N;
comparing the M-dimensional feature vectors with stored class models respectively corresponding to previously identified semantic classes of data; and
identifying as the semantic class that class which corresponds to the class model which most matched the M-dimensional feature vectors.

3. A method according to claim 1, wherein the set of semantically classifiable data is audio data.

4. A method according to claims 1, wherein the set of semantically classifiable data is visual data.

5. A method according to claims 1, wherein the set of semantically classifiable data contains audio and visual data.

6. A method according to claim 1, wherein the analysing step uses Principal Component Analysis (PCA).

7. A method according to claim 1, wherein the analysing step uses Kernel Discriminant Analysis (KDA).

8. A method according to claim 1, wherein the combining step further comprises concatenating the respectively extracted characteristic features into the respective N-dimensional feature vectors.

9. A system for generating class models of semantically classifiable data of known classes, comprising:
feature extraction means for extracting a plurality of sets of characteristic feature vectors from respective portions of a training set of semantically classifiable data of one of the known classes; and
feature combining means for combining the plurality of sets of characteristic features into a respective plurality of N-dimensional feature vectors specific to the known class;
the feature extraction means and the feature combining means being repeatably operable for each known class, wherein respective pluralities of N-dimensional feature vectors are thus obtained for each known class;
the system further comprising:
processing means arranged in operation to:
analyse the pluralities of N-dimensional feature vectors for each known class to generate a set of M basis vectors, each being of N-dimensions, wherein M<<N; and
for any particular one of the known classes:
use the set of M basis vectors, map each N-dimensional feature vector relating to the particular one of the known classes into a respective M-dimensional feature vector; and
use the M-dimensional feature vectors thus obtained as the basis for or as input to train a class model of the particular one of the known classes

10. A system for identifying the semantic class of a set of semantically classifiable data, comprising:
feature extraction means for extracting a plurality of sets of characteristic feature vectors from respective portions of the set of semantically classifiable data;
feature combining means for combining the plurality of sets of characteristic features into a respective plurality of N-dimensional feature vectors;
storage means for storing class models respectively corresponding to previously identified semantic classes of data; and
processing means for:
mapping each N-dimensional feature vector to a respective M-dimensional feature vector, using a set of M basis vectors previously generated by the third aspect of the invention, wherein M<<N;
comparing the M-dimensional feature vectors with the stored class models; and
identifying as the semantic class that class which corresponds to the class model which most matched the M-dimensional feature vectors.
